(19) United States
(12) Patent Application Publication
(10) Pub. No.: US 2020/0282410 A1
(43) Pub. Date: Sep. 10, 2020

(54) ADJUSTABLE NOZZLE ASSEMBLY OR NOZZLE ATTACHMENT FOR A LIQUID-FILLED SPRAYER

(71) Applicant: The Fountainhead Group, Inc., New York Mills, NY (US)

(72) Inventors: David Denmat, Clinton, NY (US); Jeffrey Spooner, West Winfield, NY (US); Mario Restive, Frankfort, NY (US)

(73) Assignee: The Fountainhead Group, Inc., New York Mills, NY (US)

(21) Appl. No.: 16/809,893

(22) Filed: Mar. 5, 2020

Related U.S. Application Data
(60) Provisional application No. 62/814,124, filed on Mar. 5, 2019.

(51) Int. Cl. B05B 1/12; B05B 1/30; B05B 1/28

(52) U.S. Cl. CPC B05B 1/12; B05B 1/28; B05B 1/304

(57) ABSTRACT

A nozzle adapter for a manually adjustable liquid spray nozzle and which includes features that facilitate use and protects the user from possible fluid exposure. The nozzle adapter includes a bell-shaped feature that funnels any liquid dripping from the end of the nozzle away from the user, and further includes a series of drip edges, dams, and liquid pathways that further divert any leaked liquids away from the user. Finally, the adapter includes a user touch point for adjusting the spray pattern of the nozzle that is positioned radially outwardly a greater distance than the nozzle outlet to further enhance the protective properties of the nozzle adapter.

### CROSS-REFERENCE TO RELATED APPLICATION

This application claims priority to U.S. Provisional Patent Application Ser. No. 62/814,124, filed on Mar. 5, 2019, and entitled “ADJUSTABLE NOZZLE FOR A LIQUID-FILLED SPRAYER,” the entire disclosure of which is incorporated herein by reference.

### FIELD OF THE INVENTION

The present disclosure is directed generally to an adjustable nozzle or an attachment to a nozzle for a liquid fluid sprayer that prevents the sprayed fluid from contacting the user's fingers during adjustment of the spray pattern.

### BACKGROUND

As shown in FIGS. 1a-1c, lawn and garden sprayers typically employ an outlet nozzle 10 that is manually adjustable, in order to set the fluid spray to the desired pattern. By manually turning the nozzle 10, the user may adjustably vary the fluid outlet to form straight-stream, coarse spray, and fine mist patterns. As shown in FIGS. 2a-2c, the nozzle 10 includes an elongated body 12 with a touch point area 14 provided for the user to grasp for purposes of rotating the nozzle to its desired flow pattern. The touch point area 14 is spaced proximate to and laterally from the fluid spray outlet 16 of the nozzle.

A disadvantage of the typical manual-adjustment spray nozzle 10 is that the touch point area 14 is very close to the fluid spray outlet 16, as shown in FIGS. 2a-2c. This typical touch-point location is disadvantageous because, when operating the sprayer, the sprayed fluid can drip and otherwise collect onto the surfaces that surround and comprise the nozzle spray outlet 16. The user's fingers, when grasping the nozzle 10 to adjust the spray pattern, can thus become wet with the sprayed chemical due to the unobstructed proximity of the touch point to the nozzle outlet. An example of a typical touch-point location is shown in FIG. 3. The touch point area 14 on this typical adjustable nozzle 10 is seen to be proximal to the fluid outlet 16.

Accordingly, there is a need in the art for a tool that minimizes the risks to a user of contacting hazardous liquids while spraying the liquids.

### SUMMARY

The present disclosure is directed to an adjustable nozzle assembly or an attachment to a nozzle for a liquid fluid sprayer.

According to an aspect an adapter is provided that extends along a longitudinal axis and having proximal and distal ends and used in conjunction with a liquid spray nozzle having a spray outlet from which a variety of different spray patterns can be selectively actuated by rotation of the spray nozzle, the nozzle adapter comprising: a bell-shaped region positioned in radially surrounding relation to the liquid spray nozzle, wherein the bell-shaped region tapers outwardly from a proximal position towards a distal position and terminates in a drip edge that is a first radial distance from the longitudinal axis and a first axial distance from the proximal end; and a touch point region positioned adjacent the proximal end and being manually rotatable to selectively adjust the spray pattern, the touch point region being a second radial distance from the longitudinal axis that is greater than the first radial distance.

According to an embodiment, the adapter further comprises an intermediate region extending between the bell-shaped region and the touch point region and being a third radial distance from the longitudinal axis that is less than the second radial distance, the intermediate region comprising a plurality of vent openings formed therethrough in circumferentially spaced relation to each other.

According to an embodiment, the adapter further comprises a first drip ring positioned between the intermediate region and the touch point region and being of fourth radial distance from the longitudinal axis that is greater than the first radial distance and less than the second radial distance.

According to an embodiment, the adapter further comprises a dam feature formed within the adapter and proximal relative to the vent openings.

According to an embodiment, the vent openings are elongated in shape.

According to an embodiment, the tough point region includes a knurled surface.

According to an embodiment, the tough point region is color coded.

According to an embodiment, the adapter further comprises a first drip edge positioned proximal to the touch point region.

According to an aspect an adapter is provided that extends along a longitudinal axis and having proximal and distal ends and used in conjunction with a liquid spray nozzle having a spray outlet from which a variety of different spray patterns can be selectively actuated by rotation of the spray nozzle, the nozzle adapter comprising a distal region that extends proximally from the distal end and is of a first diameter that is spaced a first radial distance from the longitudinal axis; a touch point region positioned adjacent the proximal end and being manually rotatable to selectively adjust the spray pattern, the touch point region being of a second diameter that is a second radial distance from the longitudinal axis that is greater than the first radial distance; and a first drip ring positioned between the distal region and the touch point region.

According to an embodiment, the first drip ring is of a third diameter that is a third radial distance away from the longitudinal axis that is greater than the first radial distance and less than the second radial distance.

According to an embodiment, the adapter further comprises a bell-shaped region positioned proximal to the first drip ring and distal to the touch point region, wherein the bell-shaped region tapers outwardly from a proximal position towards a distal position and terminates in a drip edge that is a fourth radial distance from the longitudinal axis that is greater than the third radial distance and less than the second radial distance.

According to an embodiment, the first drip ring is positioned a first axial distance from the touch point region and the bell-shaped region is positioned a second axial distance from the touch point region that is less than the first axial distance.

According to an embodiment, the adapter further comprises a plurality of vent openings formed through the distal region and positioned adjacent to the drip ring.

According to an embodiment, the adapter further comprises a dam feature formed within the adapter and proximal relative to the vent openings.

According to an embodiment, the tough point region is color coded.

These and other aspects of the invention will be apparent from the embodiments described below.

### BRIEF DESCRIPTION OF THE DRAWINGS

The present invention will be more fully understood and appreciated by reading the following Detailed Description in conjunction with the accompanying drawings, in which:

FIGS. 1a-1c are illustrations of prior art manually adjustable spray nozzle attached to liquid container.

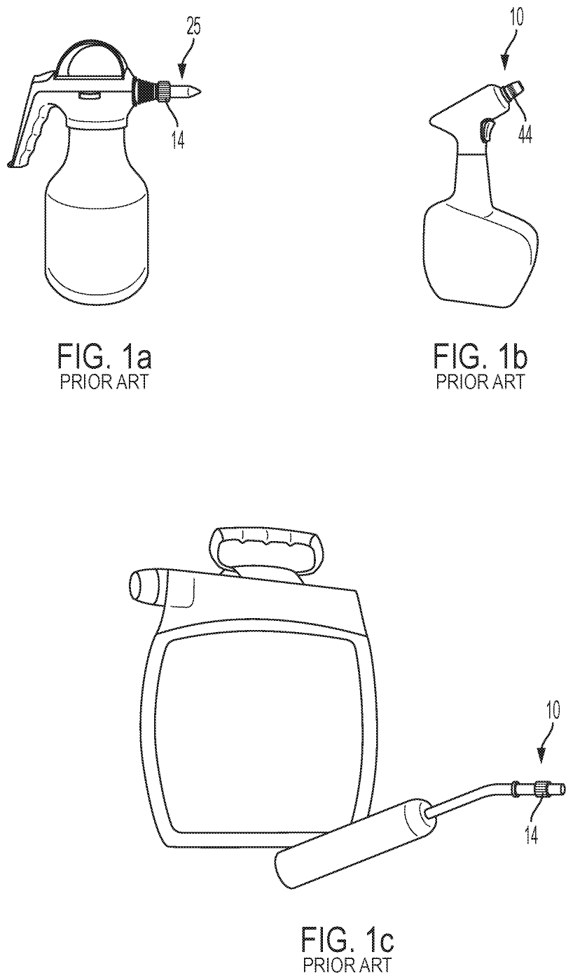

FIGS. 2a-2c are illustrations of the user touch points on prior art manually adjustable liquid spray nozzles.

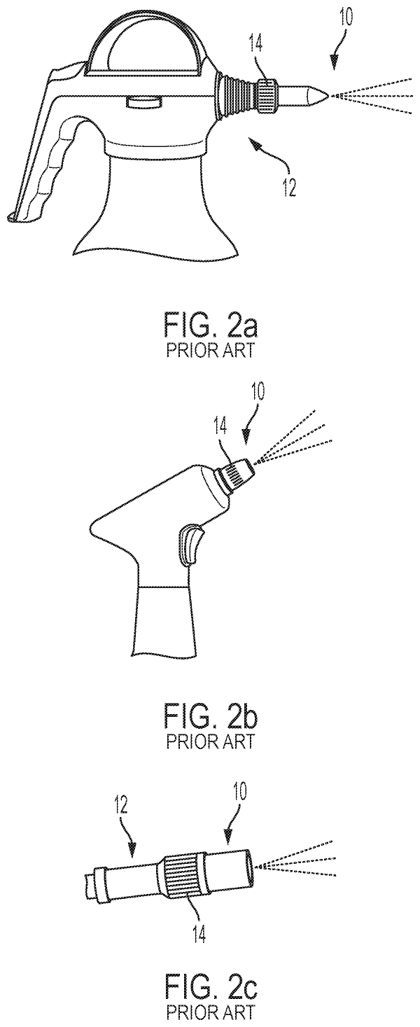

FIGS. 3a and 3b are a perspective view and an enlarged perspective view, respectively, of a user touch point on a prior art manually adjustable liquid spray nozzle.

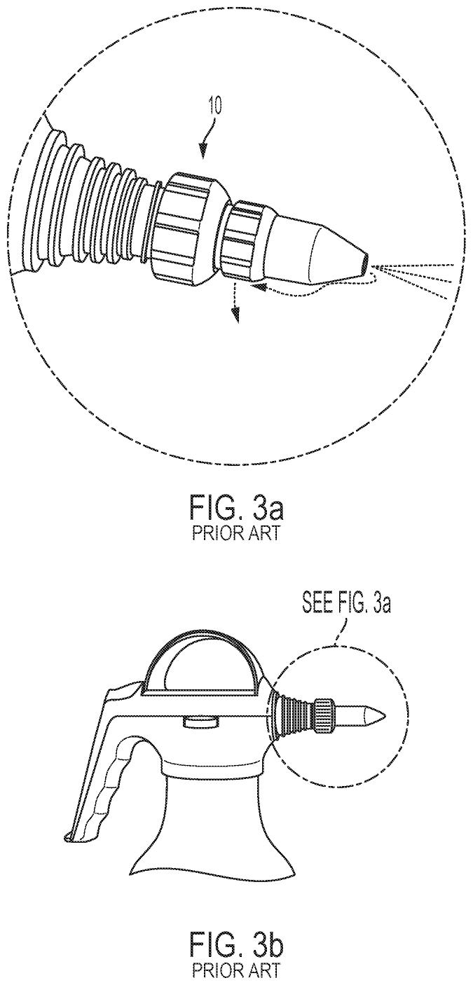

FIGS. 4a and 4b are a perspective view and an enlarged perspective view, respectively, of a nozzle adapter for a manually adjustable liquid spray nozzle, in accordance with an embodiment.

FIG. 5 is a cross-sectional perspective illustration of a nozzle adapter attached to a manually adjustable liquid spray nozzle, in accordance with an embodiment.

FIG. 6 is a cross-sectional perspective illustration of a nozzle adapter integrated with a manually adjustable liquid spray nozzle, in accordance with an embodiment.

FIGS. 7a-7c are a series of perspective, cross-section, and enlarged perspective detailed views, respectively, of a nozzle adapter attached to a manually adjustable liquid spray nozzle, in accordance with an embodiment.

FIGS. 8a-8c are a series of perspective, cross-section, and enlarged perspective detailed views, respectively of a nozzle adapter attached to a manually adjustable liquid spray nozzle, in accordance with an embodiment.

FIG. 9 is a perspective view of a nozzle adapter integrated with a manually adjustable liquid spray nozzle, in accordance with an embodiment.

FIGS. 10a-10c are a perspective view, a perspective view while in use, and a longitudinal cross-sectional view, respectively, of a nozzle adapter for a manually adjustable liquid spray nozzle, in accordance with an embodiment.

FIGS. 11a and 11b are a perspective illustration of a prior art manually adjustable liquid spray nozzle in use and illustrating the liquid flow path, respectively.

FIGS. 12a-12d are a series of a perspective view of a sprayer, and a perspective view, a side elevation view, and a longitudinal cross-section view, respectively, of a nozzle adapter attached to a manually adjustable liquid spray nozzle, in accordance with an embodiment.

FIGS. 13a-13d are a series of a perspective view of a sprayer, and a perspective view, a side elevation view, and a longitudinal cross-section view, respectively, of a nozzle adapter attached to a manually adjustable liquid spray nozzle, in accordance with an embodiment.

### DETAILED DESCRIPTION OF EMBODIMENTS

The present disclosure describes a nozzle or nozzle attachment which comprises features that facilitate use and protects the user from possible fluid exposure.

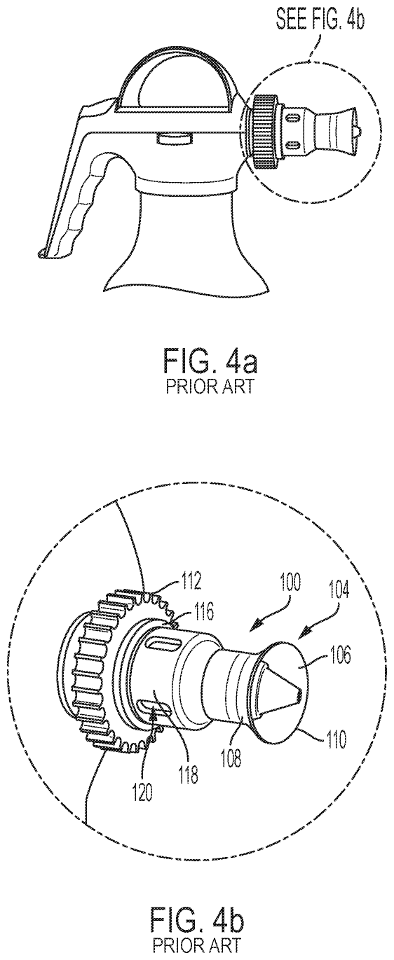

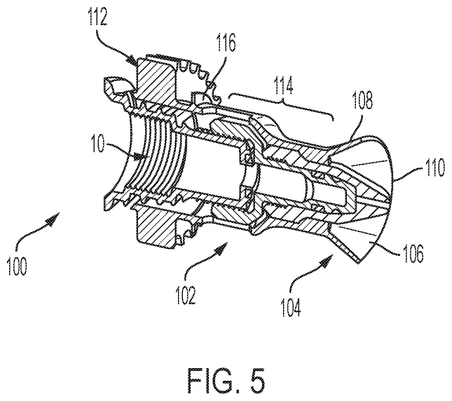

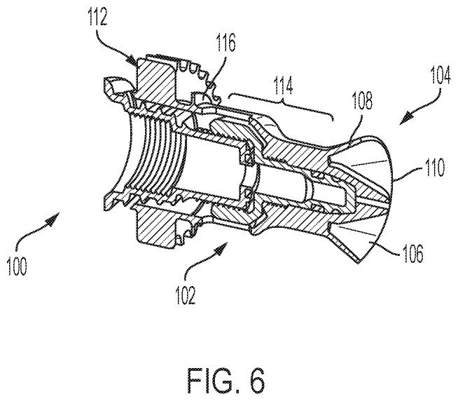

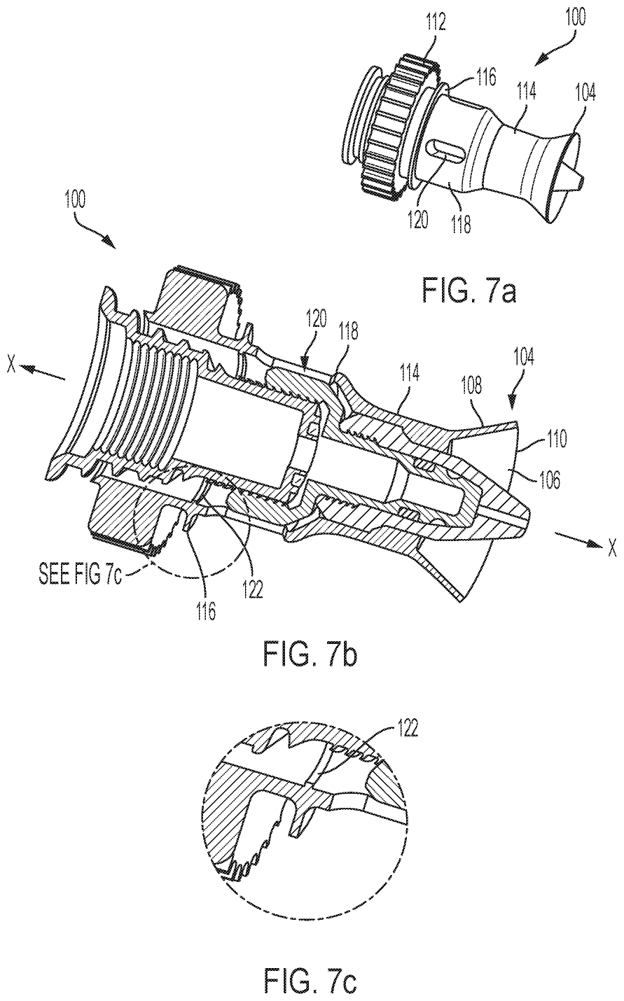

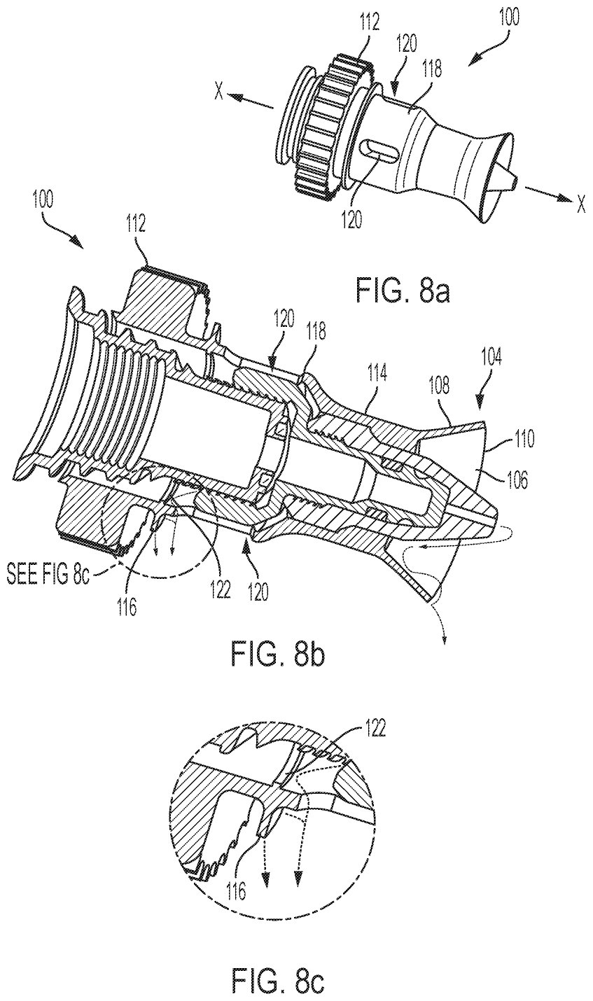

Referring to FIGS. 4-8, in one embodiment, is a nozzle (FIGS. 6-8)/nozzle attachment (FIGS. 4 and 5) 100 (wherein the nozzle attachment of FIGS. 4 and 5 is adapted for connection to a nozzle 10) that extends along a longitudinal axis X-X. Regarding FIGS. 6-8, instead of providing a separate nozzle attachment 100 as shown in FIGS. 4 and 5, an aspect of the invention is that the attachment could be integrated into a stand-alone nozzle. For that reason, while reference is made to a nozzle/nozzle assembly throughout, the two terms should be interpreted as synonymous in connection with the present invention. Furthermore, the components described herein can be viewed as equally as applying to a nozzle attachment or a nozzle that has been integrated with an attachment and the same reference numerals will be used in the drawings to refer to the same parts.

In the embodiment of FIGS. 4 and 5, nozzle attachment 100 comprises an elongated body 102 that is sized to fit over and contour the shape of nozzle 10 (while in FIG. 6, the body 102 is a part of the actual nozzle), a bell shaped/cone-shaped distal end 104 that includes an inner bell surface 106 and an outer bell surface 108 that terminate in a free drip edge 110, and a touch point area 112 at the attachment's proximal end. An intermediate section 114 extends between the bell-shaped distal region 102 and the proximal touch point area 112.

Bell shaped distal end 104 surrounds and tapers outwardly away from the nozzle spray outlet 106. Liquid that drips from spray outlet 106 will generally be collected within the distal end 104 on surface 106. With the nozzle held in a horizontal position or downwardly directed angle, any collected liquid would be directed out of distal end 104 and drip off of drip edge 110; if the nozzle was held at an upwardly directed angle the liquid would collect within distal end 104 until such time as it was moved to a horizontal position or a downwardly directed angle or could seep through a channel within nozzle attachment 100.

The bell outer surface 108 tapers outwardly away from the user and functions to dissuade or discourage the user from touching or otherwise contacting the nozzle spray end 16 or the areas therearound.

The touch point area 112 comprises a ribbed or knurled exterior surface and is or a proportionally larger diameter than the intermediate section 114 and the bell-shaped distal end 104. The knurls or ribs provide the user with a reliable griping surface to facilitate rotation of the nozzle attachment 100 (and nozzle 10 to which the attachment is rigidly connected). Its proximal position on the nozzle attachment 10 maximizes the distance between the user's fingers and the spray outlet 106, further minimizing the risk of the user's fingers contacting the liquid. Furthermore, the proportionally larger diameter maintains the user's fingers a predetermined radial distance away from the nozzle 10 that is greater than if the touch area were placed elsewhere or not of an enlarged diameter. The exterior surface of the touch point area may also be color coded to provide further indication to the user of its function.

Intermediate section 114 extends between distal bell-shaped end 104 to an exteriorly extending drip ring 116 that is positioned distally adjacent touch point area 112. From the proximal end of distal bell-shaped end 104, intermediate section 114 extends proximally there along until it transitions outwardly to a vented region 118. A series of vent openings 120 are formed through nozzle attachment 100 within the vented region 118 and serve to permit any remnant liquid collected there within to spill outwardly though the vent openings 120. Drip ring 116 is positioned at the proximal end of vented region 118 and is of a larger diameter than that or vent vented region 120. A dam feature 122 is positioned interiorly of the attachment at the proximal ends of vent openings 120 and diverts any liquid to pass through the vent openings 120. Drip ring 116 diverts any liquid dripping out through the vent openings 120 away from the touch point area 112. In addition, a drip edge positioned at the distal end of vented region 118 also diverts liquid coming through openings 120 away from the user. Thus, attachment/nozzle 100 provides at least three distinct liquid diversion points that are axially spaced from the user's fingers.

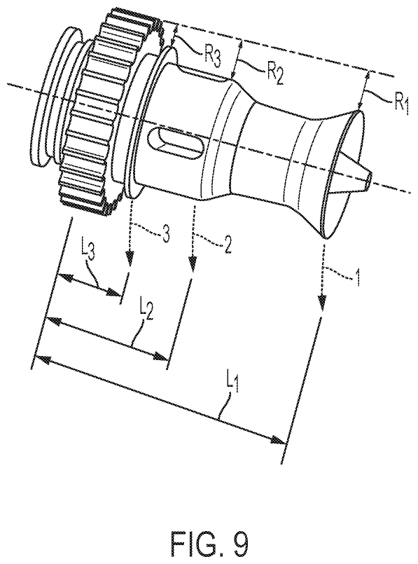

With reference to FIG. 9, the relative dimensions and proximity of the user's fingers on the touch point area 112 are illustrated. As measured from the exterior of the touch point area 112, drip edge 110 of bell-shaped end 104 extends a radial distance R1 inwardly, while vented region 118 is a radial distance R2 inwardly, and drip ring 116 is a radial distance R3 inwardly, wherein R1 is greater than or equal to R2 which is greater than R3. Consequently, and conversely, touch point area is the farthest radially from the longitudinal axis X-X, while the drip ring is the second farthest radially from the longitudinal axis, and the vented region is radially closest to the longitudinal region. In regard to the lateral distance the user's fingers would be from the various possible liquid collection surfaces, drip edge 110 is an axial distance L1 from the proximal end of touch point area 112, vented region 118 is an axial distance L2 from the proximal end of touch point area 112, and drip ring 116 is an axial distance L3 from the proximal end of touch point area 112, wherein L1 is greater than L2 which is greater than L3. Thus, nozzle attachment/nozzle 100 provides a user with a tool to change the spray pattern of a nozzle while minimizing the risk of contacting the liquid being sprayed from the nozzle.

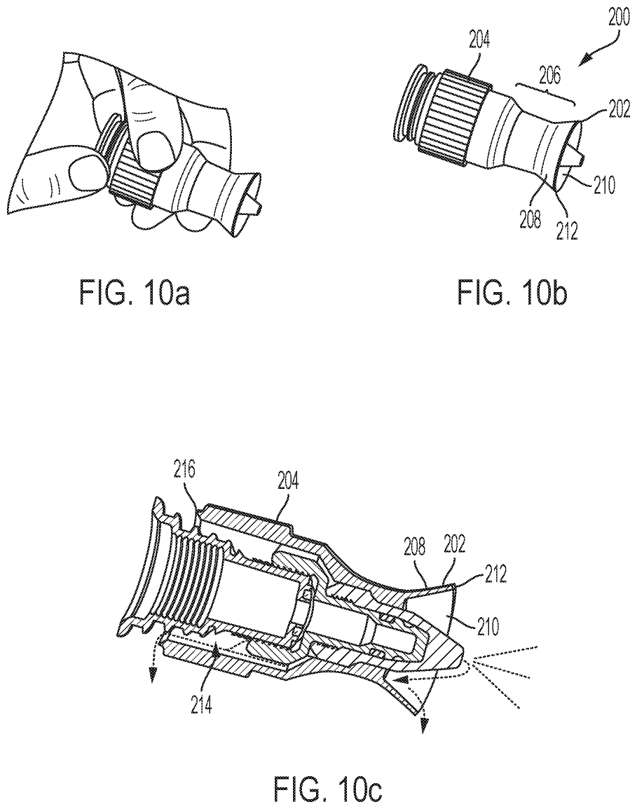

With reference to FIG. 10, another embodiment of a nozzle/nozzle attachment 200 is illustrated. Nozzle/nozzle attachment 200 extends along longitudinal axis X-X and comprises a distal bell-shaped end 202, a touch point area 204 positioned at the proximal end of the attachment/nozzle 200, an intermediate section 206 extending between the distal end 202 and proximal end 204. As with nozzle attachment 100, the bell-shaped distal end 202 comprises the outer and inner bell surfaces 208, 210, respectively, and a drip edge 212 at their boundary which serves to divert any liquid collected on the inner bell surface 210 away from the user. A flow path 214 formed within the attachment/nozzle 200 directs any stray liquid out of the unit and off of a drip edge 216 formed proximally to the end of touch point area 204. As with nozzle attachment 100, touch point area 204 is of a greater diameter than the remaining sections of nozzle/attachment 200 to facilitate maintaining radial separation between the user's fingers and the areas on which liquid can collect and divert.

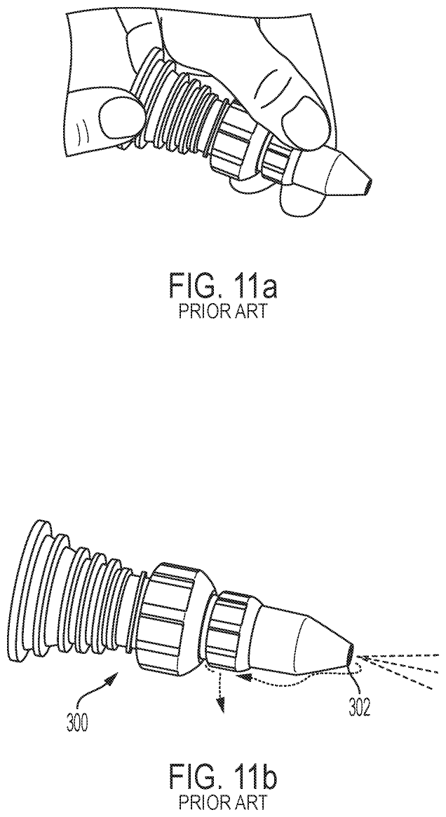

FIG. 11 shows a prior art nozzle 300 analogous to the size/shape/style of nozzle/attachment 200. With nozzle 300, liquid will exit the nozzle spray outlet 302 and may run on the outside of the nozzle where it will inevitably contact the user's finger when rotating the nozzle to change its spray pattern. The nozzle/attachment 200 eliminates or at least minimizes the risk of such contact.

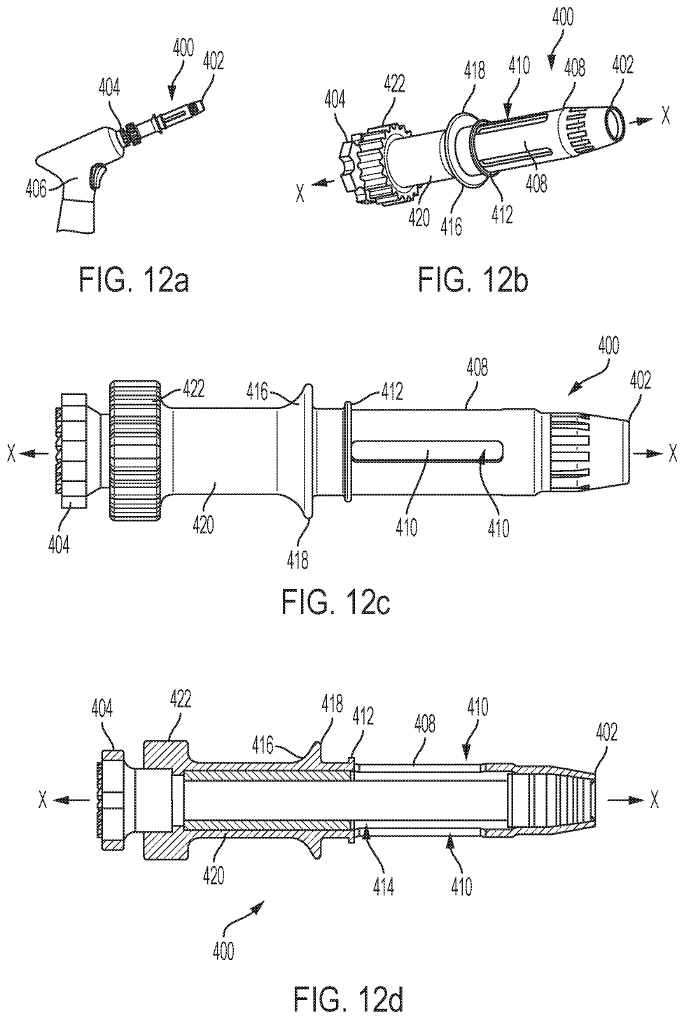

With reference to FIG. 12, another embodiment of a nozzle/nozzle attachment 400 is provided. Nozzle/nozzle attachment 400 comprises an extended nozzle configuration that extends along axis X-X between a nozzle spray outlet end 402 and a nut end 404 that serves to interconnect the nozzle/nozzle attachment 400 to a sprayer 406. As opposed to the bell-shaped distal end provided in prior embodiments, due to the extended length of nozzle/nozzle attachment 400, an elongated distal region 408 extends from the spray outlet end 402 and includes a series of elongated slotted openings 410 formed therethrough for permitting stray liquid coming from the outlet end 402 to pass through these openings 410. A first drip ring 412 of a first diameter extends radially outwardly from the proximal end of distal region 408 and serves to capture and divert liquid that passes though openings 410 away from nozzle/nozzle attachment 400. A dam feature 414 structured in the interior of distal region 408 and the proximal end of openings 410 serves to push liquid through the openings 410 where first drip ring 412 is used to divert the liquid. Any liquid that does not get diverted by and passes over first drip ring 412 will run proximally along a first intermediate region 414 of slightly smaller diameter than first drip ring 412 to a bell-shaped region 416 having the same characteristics as the bell-shaped regions 104, 202, wherein the inner bell surface will capture and divert liquid to a drip edge 418 that is of a diameter slightly larger than the diameter of drip edge 412 and serves to further divert the liquid away from the user's fingers. A second intermediate region 420 extends proximally from bell-shaped region 416 and terminates at the touch point area 422 that is of a diameter larger than that of the bell-shaped region 416, and thus at a distance that is axially farthest from axis X-X than any other point on nozzle/nozzle attachment 400, thereby keeping the user's fingers as far away from liquid as possible. Touch point area 412 is ribbed or knurled and can include indicia or color-coding to further assist the user in adjusting the spray pattern and is positioned distally adjacent nut end 404.

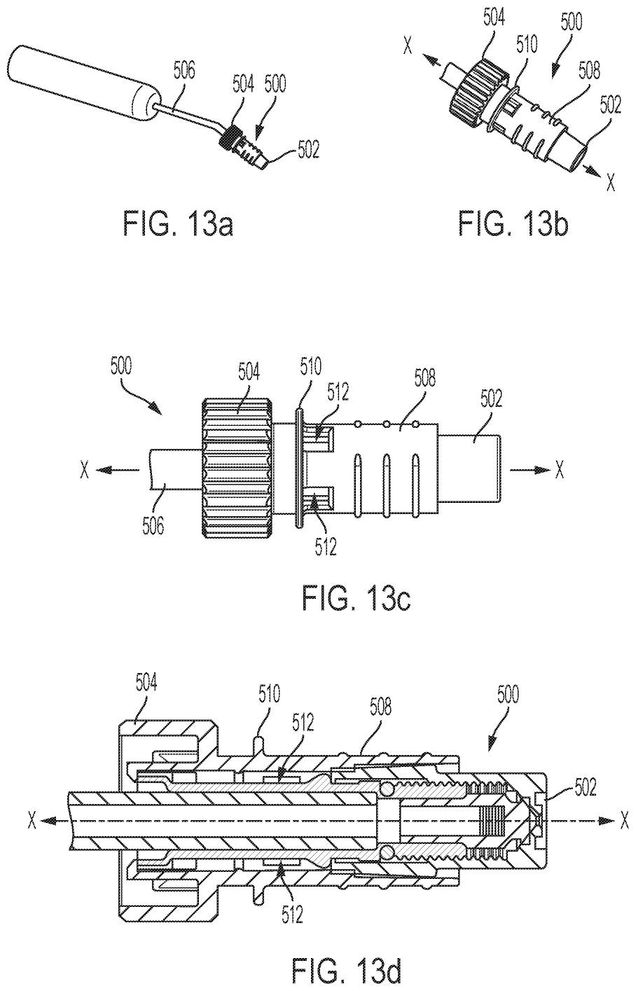

With reference to FIG. 13, another embodiment of a nozzle/nozzle attachment 500 is provided. Nozzle/nozzle attachment 500 comprises a shortened wand-end nozzle configuration that extends along axis X-X between a nozzle spray outlet end 502 and a proximal end where the touch point area 504 is positioned and where it is connected to a spray wand 506. As with the other embodiments, the tough point area 504 is knurled or ribbed and is of a larger diameter than any other area on the nozzle/nozzle attachment 500 thereby maintaining maximum distance of the user's fingers from the liquid. Nozzle/nozzle attachment 500 comprises a distal region 508 that extends proximally from the nozzle spray outlet end 502 and terminates at a drip ring 510 that is of a diameter larger than that of distal region 508 and is positioned at an intermediate position along the length of nozzle/nozzle adapter 500. A series of vent openings 512 are formed through distal region 508 in the space immediately adjacent drip ring 510. As with the other vent openings, these openings permit any stray fluid passing within nozzle/nozzle adapter 500 to escape and be diverted by drip ring 510. Nozzle/nozzle adapter terminates at its proximal end in touch point region 512 which, as with all the other touch point regions, includes a knurled or ribbed surface and is of a diameter larger than any other area of the nozzle/nozzle adapter so as to space the user's fingers as far away axially from the liquid as possible. A user can grasp touch point area 512 to rotate nozzle/nozzle adapter 500 and change the spray pattern as desired.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. An adapter that extends along a longitudinal axis and having proximal and distal ends and used in conjunction with a liquid spray nozzle having a spray outlet from which a variety of different spray patterns can be selectively actuated by rotation of the spray nozzle, the nozzle adapter comprising:
a. a bell-shaped region positioned in radially surrounding relation to the liquid spray nozzle, wherein the bell-shaped region tapers outwardly from a proximal position towards a distal position and terminates in a drip edge that is a first radial distance from the longitudinal axis and a first axial distance from the proximal end; and
b. a touch point region positioned adjacent the proximal end and being manually rotatable to selectively adjust the spray pattern, the touch point region being a second radial distance from the longitudinal axis that is greater than the first radial distance.

2. The adapter according to claim 1, further comprising an intermediate region extending between the bell-shaped region and the touch point region and being a third radial distance from the longitudinal axis that is less than the second radial distance, the intermediate region comprising a plurality of vent openings formed therethrough in circumferentially spaced relation to each other.

3. The adapter according to claim 2, further comprising a first drip ring positioned between the intermediate region and the touch point region and being of fourth radial distance from the longitudinal axis that is greater than the first radial distance and less than the second radial distance.

4. The adapter according to claim 3, further comprising a dam feature formed within the adapter and proximal relative to the vent openings.

5. The adapter according to claim 2, wherein the vent openings are elongated in shape.

6. The adapter according to claim 1, wherein the tough point region includes a knurled surface.

7. The adapter according to claim 1, wherein the tough point region is color coded.

8. The adapter according to claim 1, further comprising a first drip edge positioned proximal to the touch point region.

9. An adapter that extends along a longitudinal axis and having proximal and distal ends and used in conjunction with a liquid spray nozzle having a spray outlet from which a variety of different spray patterns can be selectively actuated by rotation of the spray nozzle, the nozzle adapter comprising:
a. a distal region that extends proximally from the distal end and is of a first diameter that is spaced a first radial distance from the longitudinal axis;
b. a touch point region positioned adjacent the proximal end and being manually rotatable to selectively adjust the spray pattern, the touch point region being of a second diameter that is a second radial distance from the longitudinal axis that is greater than the first radial distance; and
c. a first drip ring positioned between the distal region and the touch point region.

10. The adapter according to claim 9, wherein the first drip ring is of a third diameter that is a third radial distance away from the longitudinal axis that is greater than the first radial distance and less than the second radial distance.

11. The adapter according to claim 10, further comprising a bell-shaped region positioned proximal to the first drip ring and distal to the touch point region, wherein the bell-shaped region tapers outwardly from a proximal position towards a distal position and terminates in a drip edge that is a fourth radial distance from the longitudinal axis that is greater than the third radial distance and less than the second radial distance.

12. The adapter according to claim 11, wherein the first drip ring is positioned a first axial distance from the touch point region and the bell-shaped region is positioned a second axial distance from the touch point region that is less than the first axial distance.

13. The adapter according to claim 9, further comprising a plurality of vent openings formed through the distal region and positioned adjacent to the drip ring.

14. The adapter according to claim 13, further comprising a dam feature formed within the adapter and proximal relative to the vent openings.

15. The adapter according to claim 9, wherein the tough point region is color coded.
